(19) United States
(12) Patent Application Publication
(10) Pub. No.: US 2007/0048194 A1
(43) Pub. Date: Mar. 1, 2007

(54) Use of a disposable container, microfluidic device and method for processing molecules

(75) Inventors: Jurgen Schulein, Buckenhof (DE); Bjoern Grassel, Nuernberg (DE); Juergen Krause, Erlangen (DE); Roland Barten, Erlangen (DE); Dirk Kuhlmeier, Nuemberg (DE); Joerg Hassmann, Furth (DE); Hans Kosak, Bonn (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: November Aktiengesellschaft, Erlangen (DE)

(21) Appl. No.: 10/563,279

(22) PCT Filed: Jul. 15, 2003
(86) PCT No.: PCT/EP03/07645

§ 371 Date: Sep. 11, 2006

(30) Foreign Application Priority Data
Jul. 4, 2003 (DE) 103 30 409.6

(51) Int. Cl. B01L 3/00

(52) U.S. Cl. 422/102; 422/100

(57) ABSTRACT

The invention relates to the use of a disposable container comprising a cylindcr (1) containing a plunger (2, 24) that is displaceably guided in said cylinder and a connection (3) that is provided on a first end (E1) of the cylinder (1) lying opposite the plunger (2, 24), said container being designed to create a difference in pressure in a microfluidic device (13) to hold (6) an agent (F, P) for processing molecules and/or to act as a reaction vessel.

The invention relates to a use of a disposable container, to a microfluidic device, and to a method for processing molecules.

Automatic analysis devices for carrying out chemical and biochemical reactions are generally known according to the prior art. In these, solutions required for the reaction are removed from a storage reservoir by means of a suction pump and are delivered to a specimen chamber. Automatic analysis devices are also known in which solutions required for the reaction are delivered by means of a plunger pump, for example. A disadvantage of the known devices is that the solutions may become contaminated. The required solutions are generally to be presented in a defined volume. To this extent there is a risk of inexact filling by the user. Automatic analysis devices have to be carefully cleaned after each analysis. This is time-consuming. Quite apart from this, it can happen that a residue remains in the device even despite careful cleaning. Such a residue falsifies the results of subsequent analyses.

Disposable syringes are known from the field of medicine, for example from DE 33 90 336 T1. Such disposable syringes are in some cases provided already filled. A plunger guided in a cylinder is designed such that the liquid held in the cylinder can be forced out manually by means of the plunger.

Ampules for receiving liquid medicaments are also known from the medical field. Such medicaments can, for example, be injected by means of a syringe. Filling of an exact volume within the μl range is not possible.

According to the prior art, devices referred to as

microfluidic devices are also known for the detection of defined biochemical molecules. Such devices operate with small volumes. Detection of biochemical molecules, for example of DNA, is thus possible. Such a device is known from EP 0 397 424 A2 or from EP 0 189 316 B1, for example.

The object of the invention is to eliminate the disadvantages according to the prior art. The aim is in particular to specify a use, a microfluidic device and a method which permit simplified and very precise, automated preparation of a specimen for carrying out chemical detection reactions and/or chemical detection reactions. In particular, a simplified automated preparation of specimens for detection of biochemical molecules, such as DNA, is to be permitted.

This object is achieved by the features of claims 1, 22 and 50. Expedient embodiments are evident from the features of claims 2 through 21, 23 through 49, and 51 through 59.

According to the invention, the use of a disposable container is proposed which comprises a cylinder with a plunger that is guided displaceably in said cylinder, and a connector that is provided at a first end of the cylinder remote from the plunger, said container being designed to create a difference in pressure in a microfluidic device, to store an agent for processing molecules and/or to act as a reaction vessel.

Such a disposable container can be produced inexpensively. It can be filled exactly with a defined volume by means of suitable automated appliances. The filling procedure can be conducted such that contamination is excluded. The disposable container can serve not only as a storage container for the agent for processing molecules, but also as a reaction vessel. For this purpose, an agent for processing molecules can for example first be introduced into a microfluidic device, after which a solution is forced or suctioned back out of the microfluidic device and into the disposable container. The disposable containers are easy to handle. Microfluidic devices can thus be operated quickly and easily.

Within the meaning of the present invention, a “microfluidic device” is understood as a compact and easy-to-handle device for performing an analysis, synthesis, purification, modification and/or increase in concentration of molecules. Such a microfluidic device can form a closed system relative to the environment. To carry out the particular reaction, a specimen received in the microfluidic device is moved through at least one channel provided therein and, if appropriate, is brought into contact with a liquid stored in the microfluidic device. The channel is configured such that the liquid can be displaced exactly via a predetermined section and can thus be moved precisely to a predetermined location of the device.

According to one embodiment, the processing agent is a liquid, a gel or a solid or a combination of these. The solid can comprise at least one of the following constituents: soluble or suspendable particles, lyophilisate, chromatographic material, preferably an ion exchanger or an affinity matrix. The processing agent can, however, also be selected from the following group: lysis liquid, elution liquid, buffer solution, beads, enzymes, primers, reactant, reagents.

The proposed disposable containers are preferably made available as a kit. Such a kit can be arranged for defined analysis purposes or diagnostic purposes. For example, it can contain solutions required for digestion of cells, and adsorption agents for DNA. Depending on the nature of the agent present for processing of molecules, the disposable containers are advantageously designed differently in terms of their diameter or their length. In this way, it is possible to ensure that a disposable container is not accidentally attached to the wrong connector of a microfluidic system. A holder in a microfluidic apparatus is in this case configured such that only the respective correct disposable container can be inserted into it. To avoid mix-ups, it is of course also possible to provide a corresponding imprint or a color-coding on the disposable container.

The processing of the molecules can involve an analysis, synthesis, purification and/or increase in concentration of the molecules. Such reactions at all times take place in vitro.

The disposable container is expediently filled completely with the processing agent. The processing agent is in this case a liquid, a paste, a gel or such like. Complete filling is understood as filling that is substantially free from bubbles, where the proportion of gas bubbles is <5.0% by volume, expediently <1.0% by volume, preferably <0.1% by volume, particularly preferably <0.01% by volume. Liquids are expediently degassed prior to filling of the disposable container. The filling is preferably carried out under sterile conditions. It is also possible to sterilize the disposable container after it has been filled. The shelf life of the processing agent received in the disposable container is increased in this way.

The plunger can be made from an elastic material, preferably from rubber or plastic. It can have at least one circumferential seal which is symmetrical in cross section. This permits a repeated reciprocal sliding movement of the plunger, with a complete sealing action being guaranteed each time.

According to a further embodiment, the plunger is designed corresponding to the connector so that, when the plunger bears on the first end, it is possible to completely empty the cylinder and if appropriate the connector. This permits particularly exact conduct of the method; no residual volumes whatsoever remain in the disposable container. If the connector has a volume, emptying of this volume too is guaranteed.

According to a further embodiment, the plunger comprises a means for engagement of a pushing and/or pulling means. This permits simple attachment of the disposable container to a device for moving the plunger. The means for engagement can be a recess provided centrally in the plunger, for example a semispherical or conical recess, a thread, a bayonet closure or a locking closure or the like. It is also possible for a pushing and/or pulling means to be fitted on the plunger. This means can be a rod or a cylinder. In this case, the pushing and/or pulling means has, at the free end, a means for engagement in a pushing and/or pulling device. The means for engagement can involve a passage, radially protruding extensions, a flange or such like. The means for engagement is expediently configured such that it can be connected to a pushing and/or pulling rod of a pushing and/or pulling device.

According to a further embodiment, the cylinder is made from a transparent material. This permits simple visual monitoring. It can be immediately ascertained whether, for example, the cylinder is correctly filled, i.e. free from bubbles. The cylinder, in particular when used for receiving light-sensitive reagents, can also be made from a material that does not transmit light. The cylinder is preferably made from a material inert with respect to the processing agent to be received in it.

The cylinder is expediently made from an elastic plastic, preferably polypropylene. Polyethylene and polycarbonate are also suitable for production of the cylinder. A particularly good sealing action is obtained using an elastic material.

According to another embodiment, the connector is closed by a closure means. The closure means can be a rubber or plastic membrane, a ball, a cone or a closure cylinder. The ball, the cone and/or the closure cylinder are advantageously made from a plastic that is inert with respect to the received agent, or from glass.

According to another particularly advantageous embodiment, a radially inwardly protruding projection blocking a displacement of the plunger out of the cylinder is provided at a second end of the cylinder remote from the connector. This makes removal of the plunger impossible. Undesired manipulation of the disposable container is avoided. Another radially inwardly protruding projection can be provided at the second end and offers resistance to a displacement of the plunger in the direction of the connector. The further projection is expediently configured such that the plunger can be displaced in the direction of the first end only upon application of a predetermined force. The force is expediently chosen such that, before a displacement of the plunger, the connector is brought into a correct position of connection to the connector piece. As soon as this is the case, a further axial displacement of the disposable container is no longer possible. The force acting on the further projection is then of such an order that the resistance thus formed can be overcome and the plunger can be displaced in the direction of the first end. In addition to ensuring correct and leaktight attachment of the disposable container to the microfluidic apparatus, the provision of the further projection has the additional advantage of ensuring that liquid received in the disposable container does not escape before a completely leaktight connection is produced. The plunger can be moved only after a leaktight connection has been produced. The further projection expediently has a radially symmetrical design. This avoids uneven attrition or damage of the plunger as it overcomes the further projection.

According to a further embodiment, a means is provided for automatic reading out of information concerning the processing agent received in the disposable container. This means can be a barcode, a transponder, a chip or a specific shaping. A barcode can, for example, be printed on the outside of the cylinder or can be applied by way of a label. A transponder or a suitable chip can be embedded at a suitable location of the disposable container. It is also possible for the cylinder to have a specific shaping, for example projections or recesses which are provided on the outside and which contain the information in coded form.

According to a further aspect of the invention, a microfluidic device is proposed for processing molecules, with an apparatus comprising at least one channel for conveying a specimen, at least two connector pieces for attachment of two disposable containers being provided on the channel, each of the disposable containers having a cylinder with a plunger guided displaceably therein, and a connector provided at a first end of the cylinder remote from the plunger, and the disposable containers being attached, via the connector provided respectively thereon, to one of the connector pieces so that, by displacement of one of the plungers, liquid can be conveyed through the channel.

The proposed microfluidic device has a particularly simple design. It is possible to dispense with the use of micropumps and such like. A pressure for displacing the liquid in the channel of the microfluidic device is generated by the displacement of the plungers. The disposable containers are not only used to store agents for processing molecules, but can also serve as a reaction chamber. Upon attachment of at least two disposable containers to the microfluidic device, it is possible, for example, to purify or break up biological material by moving a liquid back and forth between the disposable containers. The proposed microfluidic device has a surprisingly simple construction. It is easy to handle. Using the proposed disposable containers dispenses with the need for manually introducing exact volumes, for example of liquids required to carry out reactions. Contamination is practically ruled out. The proposed microfluidic devices allow exact results to be obtained quickly and reliably.

According to one embodiment, the channel is a channel system comprising several interconnected channels. The channel or the channel system can be designed at least in some sections with a meandering configuration. The apparatus can, in conjunction with the channel, comprise a microfluidic mixing chamber and/or a microfluidic reaction chamber and/or a microfluidic detection chamber and/or a bubble trap. The channel has a diameter of at most 2 mm, preferably of less than 1.5 mm.

The apparatus can also comprise at least one means selected from the following group: sensor, electrode, temperature unit, sieve, filter, membrane, affinity matrix, pre-stored substance or magnet. Moreover, a connection channel can be provided connecting the connector piece to the channel. In addition, an inlet opening can be provided which is connected to the channel and can be closed preferably by means of a first valve. Moreover, an outlet opening can be provided which is connected to the channel and can be closed preferably by means of a second valve. The proposed embodiments of the apparatus permit differentiated and automated conduct of the method. The arrangement and design of the channel are expediently chosen such that the desired reaction can be carried out in a simply and quick way.

By means of the displacement of the plungers, liquid can advantageously be conveyed into the other disposable container. In the process, the plunger in the other disposable container can be forced back. It is also possible, however, that the plunger in the other container is drawn back by a pull rod.

In a particularly advantageous embodiment, each connector piece comprises a tube piece, preferably a hollow needle, for opening a closure means which closes the connector. The connector piece or the tube piece can be closed by a further closure means. The latter can be a rubber or plastic membrane or such like. Contamination of the apparatus and/or of a liquid stored therein is in this way avoided. The disposable container can expediently be a disposable container having the above-described features.

Each of the disposable containers can have a connector corresponding to the connector pieces. This permits simple and leaktight connection of the disposable containers to the connector piece. The connection can be closed by a closure means, for example a plastic or rubber membrane, a metal foil or such like.

According to a particularly advantageous embodiment, the apparatus comprises a mdeans for fixing the disposable container in a fixed position relative to the connector piece. This avoids undesired detachment of the connector from the connector piece. It is not possible for leaks to occur, in particular when a liquid is being moved from the disposable container into the apparatus or from the apparatus into the disposable container. The fixing means can, for example, be a thread, a bayonet closure or such like. Thus, for example, the connector piece can have an internal thread and the connector can have an external thread. Contamination of the agent received in the disposable container and used for processing molecules is avoided.

Advantageously, the apparatus comprises at least one preferably cylindrical recess which corresponds to the external diameter of the disposable container and which is used for guiding the connector of the disposable container into a position of engagement with the connector piece. This facilitates the connection of the disposable container. The proposed microfluidic apparatus is compact, stable and robust. By virtue of its configuration, it can be easily inserted into an appliance for automatic movement of the plungers. A further advantage of the compact design of the microfluidic apparatus is that it is particularly easy to transport, package and store. An incorrect and possibly insufficiently leaktight connection is prevented.

Moreover, the fixing means can comprise a means which ensures that the disposable container pushed completely into the recess and engaging in the connector piece is held in a fixed position. This prevents undesired detachment of the connector from the connector piece. The holding means can, for example, involve at least one first locking means engaging round the edge of the second end of the disposable container.

According to a further embodiment, a distance between the first locking means and the connector piece is chosen such that the disposable container can be inserted into the recess without a closure means provided thereon being opened. This makes it possible for the disposable container to be inserted into one of the predetermined recesses by the manufacturer. This avoids incorrect insertion of the disposable containers by the user. The apparatus can be delivered by the manufacturer in a prefabricated state with the disposable containers suitable for the particular. purpose fitted on it. Such a pre-fabricated apparatus, which can be designed for example in the manner of a cartridge, then simply has to be introduced into a suitable appliance for automatic movement of the plungers and filled with the specimen that is to be processed. Incorrect operations and contamination are practically excluded with a pre-fabricated apparatus of this kind.

The disposable container is received in the recess expediently with the closure means unopened. Second locking means can be provided on the cylinder of the disposable container and/or on the inner wall of the recess. The second locking means can be designed such that the disposable container, for example by means of pressure exerted on its plunger, can be displaced into a locking position in which the connector closes the connector piece in a liquid-tight manner. Such a design is expedient if the connector piece or tube piece are not closed by a second connection means. The second locking means can also be designed such that the disposable container can be displaced from the first locking position to a second locking position in which the connector closes the connector piece in a liquid-tight manner and the tube piece pierces the closure means. Only in the second locking position is a connection established between the disposable container and the channel. It is then possible, for example, to force a liquid from the disposable container into the channel.

The channel is advantageously filled with liquid. In this way, a bubble-free column of liquid can easily be produced throughout the entire device. This permits particularly exact displacement of the liquid in the channel.

According to a further embodiment, several recesses can be provided on one side of the apparatus. This makes the construction of an appliance for automatic movement of the plungers in the disposable containers easier and less expensive. In this case, such an appliance simply has to be equipped with a large number of suitably juxtaposed push rods suitable for pressing the plungers down, these push rods being moved in accordance with a predetermined program. In addition, the parallel arrangement of the recesses contributes to a particularly compact configuration of the device according to the invention.

The apparatus is advantageously made in one piece from plastic. The costs involved in producing the proposed apparatus are not especially high. The apparatus can be produced by injection molding, for example. The device made up of the combination of the apparatus and the disposable containers can as a whole be produced without excessive outlay. It can be provided in the form of a disposable device.

According to a further embodiment, the apparatus can comprise a means for automatic reading out of information concerning the agent received in the apparatus. The means in question can be a barcode, a transponder, a chip or a specific shaping of the apparatus.

The microfluidic device can be configured as a kit comprising the apparatus and several of the disposable containers according to the invention. The disposable containers can already be pushed captively into the recesses, in which case their closure means are of course still closed. Such a kit and such a microfluidic device is particularly easy to store and transport and can be operated particularly easily by the user.

According to a further aspect of the invention, a method is proposed for processing molecules, with the following steps:

provision of at least two disposable containers, each of which comprises a cylinder with a plunger guided displaceably therein, and a connector provided at a first end of the cylinder remote from the plunger,

provision of a microfluidic apparatus having at least one channel, at least two connector pieces for attachment of the disposable containers being provided on the channel,

attachment of the disposable containers, via the connectors provided on them, to the connector pieces,

displacement of one of the plungers so that a liquid is conveyed in the channel.

The proposed method permits particularly simple processing of molecules. The pressure for moving or conveying the liquid in the channel of the apparatus is generated by displacement of the plungers in the disposable containers. In this way, the liquid can easily be conveyed from one site to another in the apparatus. In particular, no micropumps and such like are needed. By virtue of the exact positioning of the liquid in the apparatus, the number of valves required can be reduced.

The liquid is expediently contained in one of the disposable containers. It is also possible for liquid to be pre-stored in the channel. This permits simple production of a bubble-free column of liquid in the apparatus. The apparatus can be stocked as a further disposable part. The liquid can be conveyed from one container into the other. During filling of one of the disposable containers, the plunger held in the latter is expediently displaced by the pressure of the liquid. In this case, it is not necessary to pull the plunger by means of a special pulling device in order to convey the liquid into the disposable container. By displacement of one of the plungers, a liquid located in the channel can be displaced into a predetermined, preferably meandering section of the channel and/or into a microfluidic mixing chamber and/or into a microfluidic reaction chamber and/or into a microfluidic detection chamber and/or into a bubble trap. The displacement of the plungers permits an exact displacement of the liquid. The liquid can be processed at specific locations in the channel in accordance with a predetermined program. The predetermined section of the channel can for this purpose comprise a meandering channel and/or a microfluidic detection chamber. In order to control the movement of the liquid in the channel, at least one valve provided therein can also be opened and/or closed in accordance with a predetermined program. The movements of the plungers also take place according to the predetermined program, with the result that the liquid in the channel and in the disposable containers is moved in accordance with predetermined reaction steps.

According to a further embodiment, the disposable containers are pushed into recesses provided on the apparatus. This allows the connectors provided on the disposable containers to be guided exactly toward the connector pieces of the apparatus. When the connector is attached to the connector piece, the disposable container is expediently fixed relative to the connector piece. A fixing means can be provided for this purpose. The fixing expediently takes place only when the connector is correctly attached to the connector piece. It is thus possible to avoid producing a connection that is not leaktight.

According to a further embodiment, the disposable container, in the recess of the apparatus, can be displaced into a first locking position such that the connector closes the connector piece in a liquid-tight manner. Moreover, the disposable container can be displaced from the first locking position into a second locking position such that the connector closes the connector piece in a liquid-tight manner and the tube piece pierces the closure means. Only in the second locking position is a connection established between the disposable container and the channel.

By means of the displacement of the plungers, the liquid is advantageously conveyed in the apparatus in such a way that the steps required for carrying out at least one of the following processes are executed: washing, purification, PCR, detection. Said processes are suitable in particular for detection of DNA from different specimens.

Illustrative embodiments of the invention are explained in more detail below with reference to the drawings, in which:

FIG. 1 shows a schematic sectional view of a first disposable container,

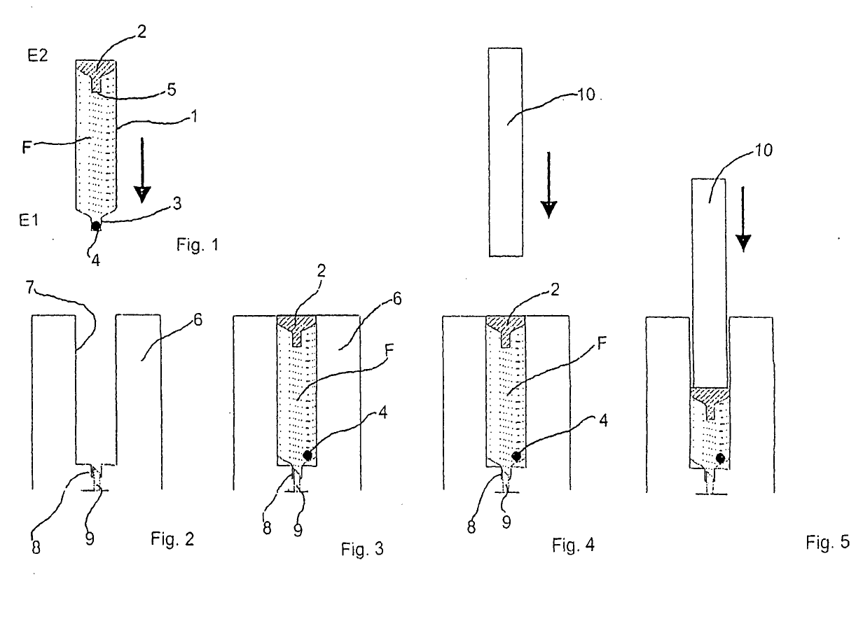

FIG. 2 shows a schematic partial sectional view of a first microfluidic apparatus,

FIG. 3 shows the partial sectional view according to FIG. 2, with the disposable container inserted,

FIG. 4 shows the partial sectional view according to FIG. 3 with a push rod,

FIG. 5 shows the partial sectional view according to FIG. 4 with the plunger partially pressed in,

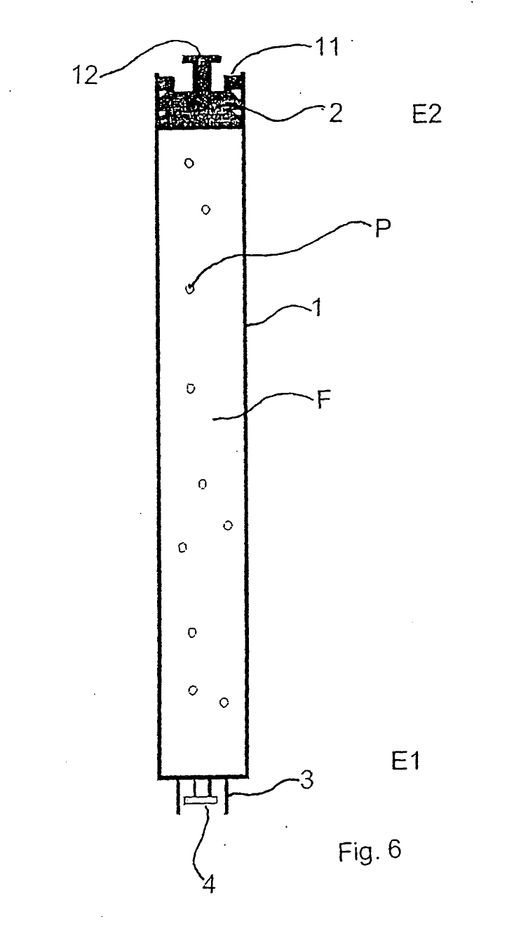

FIG. 6 shows a schematic sectional view of a second disposable container,

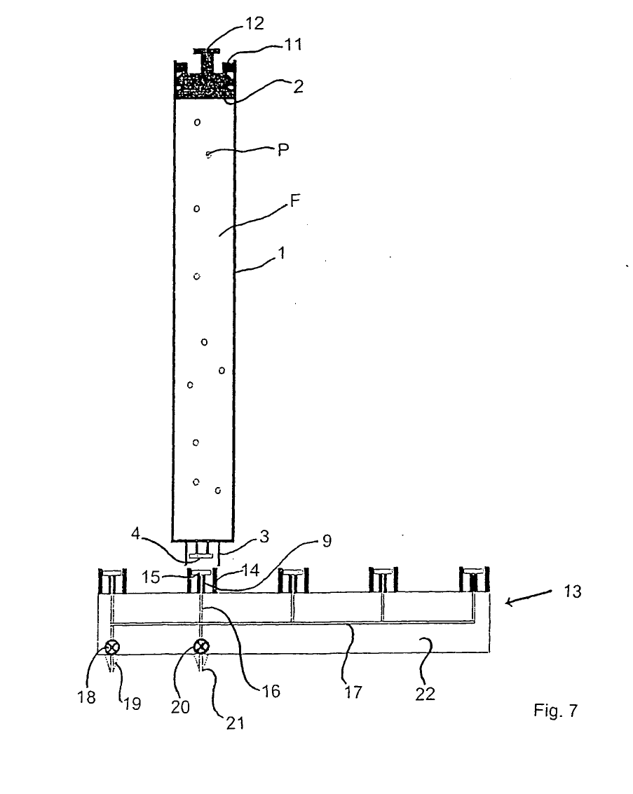

FIG. 7 shows a schematic sectional view of a microfluidic apparatus with the second disposable container according to FIG. 6,

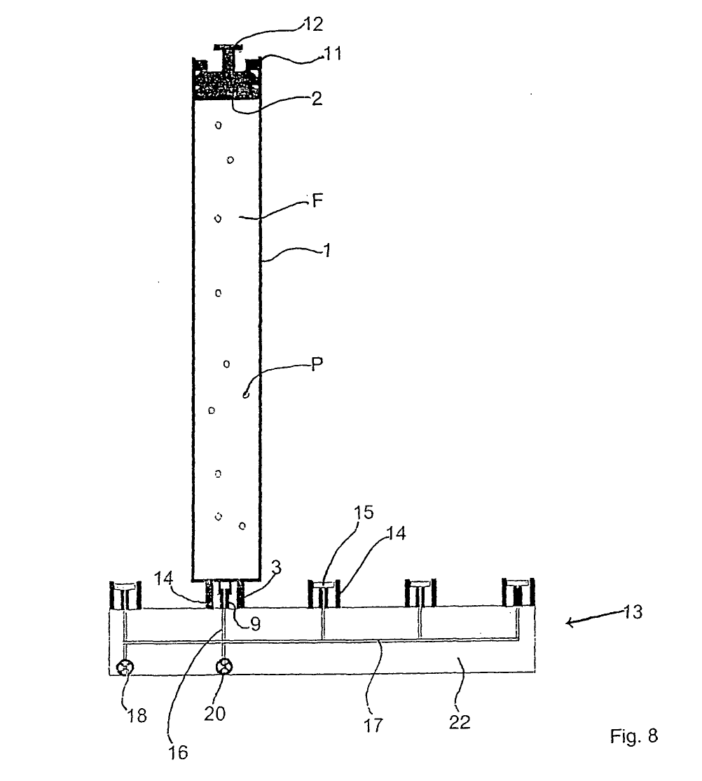

FIG. 8 shows the arrangement according to FIG. 7, the second disposable container being attached to the microfluidic apparatus,

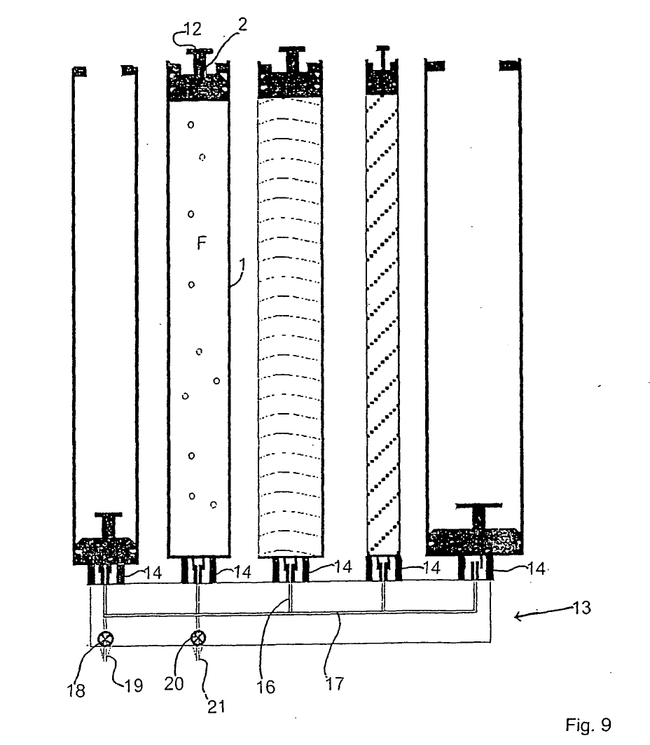

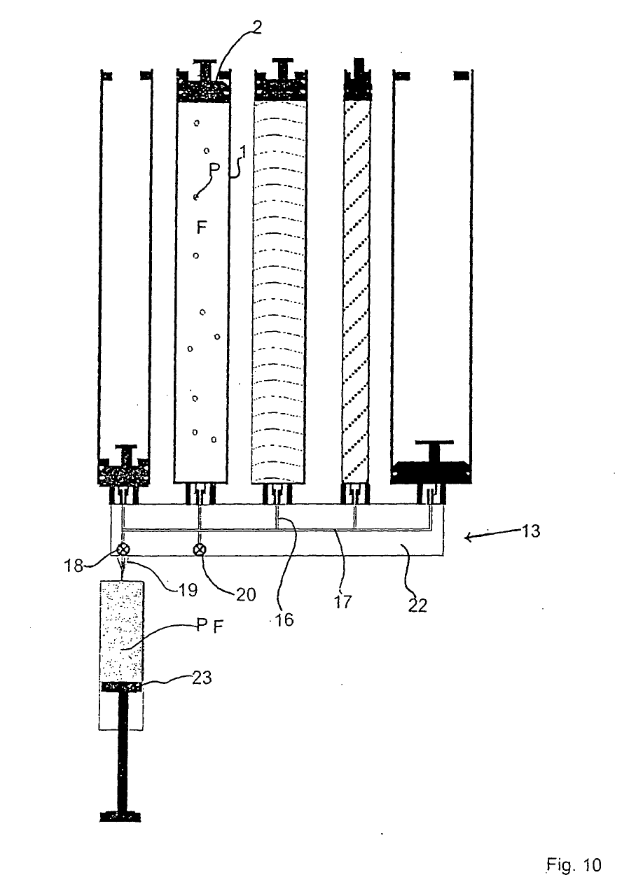

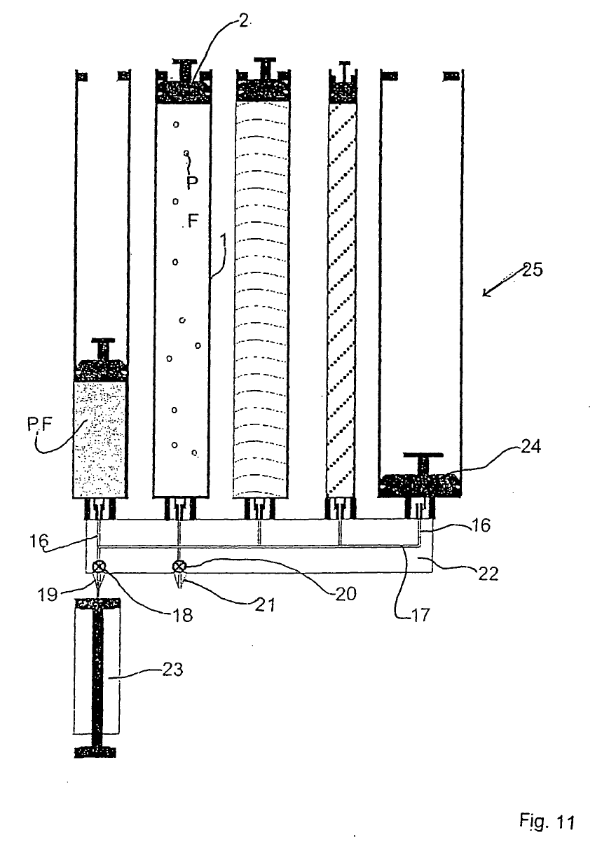

FIG. 9 shows the arrangement according to FIG. 8, with further disposable containers being attached,

FIG. 10 shows the arrangement according to FIG. 9, in which a specimen container is attached,

FIG. 11 shows the arrangement according to FIG. 10, in which the specimen container has been emptied,

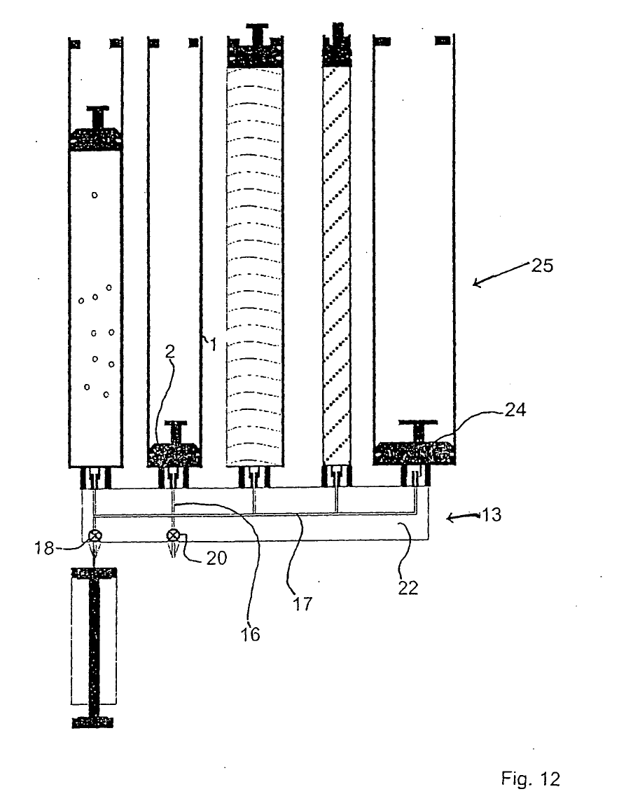

FIG. 12 shows the arrangement according to FIG. 11, in which the second disposable container has been emptied,

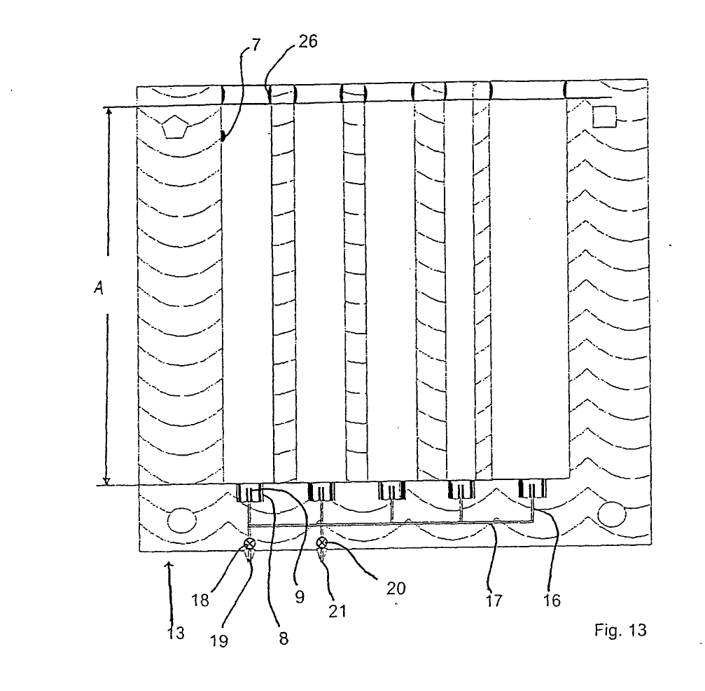

FIG. 13 shows a sectional view of a further microfluidic apparatus, and

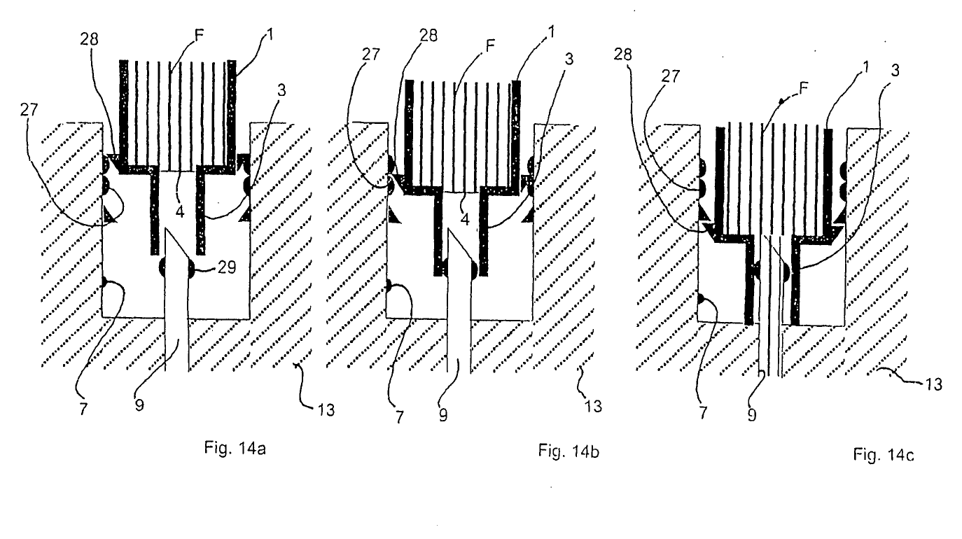

FIGS. 14a-14c show sectional views of the connector and of the connector piece in different locking positions.

FIG. 1 shows a schematic sectional view of a first disposable container. A plunger 2, made for example from plastic or rubber, is guided displaceably in a cylinder 1 which is expediently made from a transparent plastic, for example polyethylene or polypropylene. A connector 3 is provided at a first end E1 of the cylinder 1 remote from the plunger 2. The connector 3 is closed by a closure means 4, here for example in the form of a glass ball. A liquid F is received in the volume formed by the cylinder 1 and by the plunger 2 located in the latter. This can, for example, be a lysis liquid, an elution liquid, a buffer solution or such like. At its side directed toward the first end E1 of the cylinder 1, the plunger 2 is designed corresponding to the first end E1 of the cylinder 1. It has in particular a projection 5 corresponding to the shape of the connector 3. If the plunger 2 is pressed completely as far as the first end E1, the projection 5 fills the connector 3, such that complete emptying of the liquid F from the cylinder 1 and from the volume formed by the connector 3 is possible. At the side of the plunger 2 directed away from the projection 5, a central recess 7, a central projection 5 or the like can be provided for engagement of a push rod and/or pull rod. A second end of the cylinder 1 remote from the first end E1 is designated by reference label E2.

FIG. 2 shows a sectional view of a microfluidic device 13, specifically a holder 6 for the disposable container shown in FIG. 1. The holder 6 has a cylindrical recess 7 corresponding to the diameter of the cylinder 1. The recess 7 is configured such that the disposable container can be pushed into it. The connector 3 is guided such that it comes correctly into a position of engagement with a connector piece 8. The connector piece 8 can include a hollow needle 9 with which the closure means 4 is pierced or is pressed into the cylinder 1, and thus a connection of the cylinder 1 to the microfluidic apparatus 13 is established.

FIG. 3 shows the disposable container attached to the connector piece 8 using the holder 6. To transfer the liquid F, a push rod 10 can be used to press the plunger 2 in the direction of the connector piece 8. This situation is shown in FIGS. 4 and 5.

FIG. 6 shows a second disposable container in cross section. At the second end E2, the cylinder 1 has a radially inwardly facing retainer means 11. The retainer means 11 prevents the plunger 2 from being displaced past the second end E2. At its side directed away from the connector 3, the plunger 2 comprises an engagement means 12 for connection 3 to a push rod and/or pull rod. As is shown here, the engagement means 12 can for example be configured in the form of a punch. Other suitable configurations are of course also possible. The closure means 4 is designed as a membrane in the present illustrative embodiment. This membrane can be a plastic membrane or rubber membrane. It is expediently a plastic film that has been formed in one piece with the cylinder 1. The cylinder 1 can be produced in one piece with the plastic film, for example by injection molding. As is shown in FIG. 6, particles P can be suspended in the liquid F.

FIG. 7 shows in cross section a microfluidic apparatus 13 which comprises several further connector pieces 14 lying alongside one another. The further connector pieces 14 are closed by a further closure means 15 such that contamination of the microfluidic apparatus 13 is ruled out. The further closure means 15 can also be a plastic film, a rubber membrane or such like. Each of the further connector pieces 14 is connected via a connection channel 16 to a channel 17 connecting the connection channels 16. The channel 17 is also connected via a first valve 18 to an inlet opening 19 and via a second valve 20 to an outlet opening 21. The connection channels 16 and the channel 17 expediently have a diameter in the range of from 1 to 2 mm. They are worked into a base plate 22 made from transparent plastic. Each of the connector pieces 8, 14 comprises a hollow needle 9 for piercing the closure means 4.

FIG. 8 shows the microfluidic apparatus 13, the second disposable container being attached via the connector 3 to the further connector piece 14. The hollow needle 9 penetrates the connector 3 such that a sealed connection is established. The liquid F can now be moved through the hollow needle 9 into the connection channel 16 and into the channel 17 by displacement of the plunger 2 in the direction of the connector 3.

FIG. 9 shows a sectional view of the microfluidic apparatus 13 according to FIG. 8, second disposable containers being in this case attached to all the further connector pieces 14. As will be seen from FIG. 9, the diameter of the second disposable containers can be different. In this way, recesses 7 provided on the microfluidic apparatus 13 can be configured such that only certain disposable containers can in each case be fitted therein. Incorrect operation caused by attaching a disposable container to the wrong connector piece 14 can in this way be prevented. The disposable containers shown in FIG. 9 are otherwise identical to the second disposable container.

FIG. 10 shows the microfluidic apparatus 13 according to FIG. 9, a syringe 23 in this case being attached to the inlet opening 19, in which syringe a specimen liquid PF is received. By means of the syringe 23, the specimen liquid PF can be pressed for example into the second disposable container lying opposite it. To do so, it is necessary to open the first valve 20 and hold a further plunger 24 of a further disposable container 25 pressed down. In this case, the specimen liquid PF is pressed via the connection channel 16 into the disposable container lying opposite the syringe 23. By means of the pressure applied, a plunger 24 located therein is displaced (see FIG. 11).

The transferred specimen liquid PF can then be mixed with the liquid F contained in the cylinder 1, for example by pressing down the plunger 2. To do this, it is necessary to press the plunger 2 down and once again secure the second plunger 24 in its position, and to keep the first valve 18 and the second valve 20 closed (see FIG. 12). The first valve and/or second valve can be a simply configured one-way valve which, as its valve body, comprises a spring-loaded ball or a spring-loaded cone, for example. A one-way valve of this kind is arranged such that a flow of liquid is possible in the direction of the channel and, by means of a pressure generated in the channel, the valve body is pressed into its closure position. As the valve body is moved away from its closure position from the outside, emptying can take place via the valve. However, the first valve and/or the second valve can also be a simply configured multi-way valve, for example a diaphragm valve.

By means of a program-controlled and predetermined movement of the plungers 2, 24 of the disposable containers, the specimen liquid PF can be acted on in succession by several different liquids. It can be intensively mixed with the liquids. A simple breaking-up of cells contained in the specimen liquid PF is possible, for example. As soon as the cells are broken up, DNA molecules contained in them can be separated off by magnetic beads received in the disposable containers and are forwarded to a further detection method for analysis.

FIG. 13 shows a further illustrative embodiment of a microfluidic apparatus 13. In contrast to the microfluidic apparatus 13 shown in FIGS. 7 through 12, this one has recesses 7 on one side, preferably arranged in parallel, for insertion of disposable containers (not shown here). At their ends remote from the connector piece 8, the recesses 7 have first locking means 26. The first locking means 26 serve to ensure that a disposable container pushed into the recess 7 cannot readily be removed again from the recess 7. A distance A between the first locking means 26 and the connector piece 8 is chosen such that a disposable container can be pushed fully into the recess 7 without, in the process, a closure means 4 provided on its connector 3 being pierced by the hollow needle 9. The disposable container can thus be arranged captively with the microfluidic apparatus. To set the device according to the invention in operation, all that remains to be done is to move the disposable container in the direction of the connector piece 8 and thus attach it to the microfluidic apparatus 13.

The sectional views in FIGS. 14a through 14c show an advantageous embodiment of the connection of the disposable container to the microfluidic apparatus 13. Reference number 27 designates second locking means provided in the recess 7 near the connector piece 8. In the area of the connector 3 of the disposable container, third locking means 28 are provided on the cylinder 1 and are designed corresponding to the second locking means 25. The hollow needle 9 is provided with a sealing means 29 designed for example as an O-ring.

In the first position shown in FIG. 14a, the disposable container is pushed into the recess 7 of the microfluidic apparatus 13. No sealed connection is established between the connector 3 and the sealing means 29 provided on the hollow needle 9. The closure means 4 is closed.

In the second position shown in FIG. 14b, the disposable container is located in a first locking position. In this position, the connector 3 engages over the sealing means 29. The opening formed by the hollow needle 9 is thus closed in a leaktight manner by the connector 3.

In FIG. 14c, the disposable container is located in a second locking position. The hollow needle 9 passes through the closure means 4 (not shown here). A fluidic connection is established between the hollow needle 9 and the disposable container.

It will be evident from the illustrative embodiments that the proposed microfluidic apparatus can be easily charged with various combinations of reagents, agents, buffers and such like. The proposed device can be used for a wide variety of assays. To do so, it is necessary simply to fill the disposable containers with the required reagents, agents and such like. The disposable containers themselves and the microfluidic apparatus do not have to be altered for this purpose. They can also be made very inexpensively from injection-molded plastic. This allows the disposable containers and also the microfluidic apparatus to be designed as throw-way parts. At the same time, an extremely precise reaction is ensured. Defined concentrations and volumes can easily be made ready in the disposable containers. Since the proposed system has a completely closed design, contamination is avoided. The proposed device is eminently suitable for automated detection of DNA or similar biochemical molecules. An appliance provided for automatic control of the movements of the plungers 2, 24 of the disposable containers can be made relatively easily and inexpensively. Such an appliance does not require very much maintenance since there is no escape of liquids from the proposed device. The proposed disposable containers permit simple and flexible storage, packaging and manufacture of the proposed device.

List of Reference Labels

1 cylinder
2 plunger
3 connector
4 closure means
5 projection
6 holder
7 recess
8 connector piece
9 hollow needle
10 push rod
11 retainer means
12 engagement means
13 microfluidic apparatus
14 further connector piece
15 further closure means
16 connection channel
17 channel
18 first valve
19 inlet opening
20 second valve
21 outlet opening
22 base plate
23 syringe
24 further plunger
25 further disposable container
26 first locking means
27 second locking means
28 third locking means
A distance
F liquid
P particles
PF specimen liquid

1-59. (canceled)

60. An apparatus comprising a microfluidic device and at least two disposable containers, the microfluidic device comprising at least one channel, each disposable container comprising a cylinder and a plunger, and the disposable containers fluidly connectable to the microfluidic device.

61. The apparatus of claim 60, wherein the microfluidic device channel is a channel system comprising a plurality of interconnected channels.

62. The apparatus of claim 60, wherein the microfluidic device channel is in fluidic connection with at least one chamber selected from the group consisting of a microfluidic mixing chamber, a microfluidic reaction chamber, a microfluidic detection chamber, a bubble trap chamber, and any combination thereof.

63. The apparatus of claim 60, wherein the microfluidic device channel has a diameter equal to or less than about 2 mm.

64. The apparatus of claim 60, wherein the microfluidic device channel has a diameter equal to or less than about 1.5 mm.

65. The apparatus of claim 60, wherein the microfluidic device includes at least one component selected from the group consisting of a sensor, an electrode, a temperature unit, a sieve, a filter, a membrane, an affinity matrix, a pre-stored substance, a magnet, and any combination thereof.

66. The apparatus of claim 60, wherein the microfluidic device further comprises an inlet opening operatively associated with the channel and a first closure member.

67. The apparatus of claim 66, said microfluidic device further comprising an outlet opening operatively connected to the channel and a second closure member.

68. The apparatus of claim 67, wherein at least one of the first and second closure members comprises a valve.

69. The apparatus of claim 60, further comprising first and second connectors, wherein the first connectors are operatively connected to each disposable container and wherein the second connectors are operatively connected to the microfluidic device, wherein the first connector is operatively engagable with the second connector.

70. The apparatus of claim 69, wherein the microfluidic device includes a recess corresponding to the external diameter of the disposable container, the recess providing guidance of the first connector into a position of engagement with the second connector.

71. The apparatus of claim 70, wherein the microfluidic device is engagable in a fixed position relative to the second connector.

72. The apparatus of claim 71, wherein the disposable container is maintained in the fixed position by a frictional engagement of the disposable container in a microfluidic device recess.

73. The apparatus of claim 70, wherein the microfluidic device recess comprises a first detent and a second locking detent along the circumference of the recess, each of the detents spaced apart along the length of the recess.

74. The apparatus of claim 73, wherein the disposable containers each include a closure and wherein distance between the first detent and the second detent allows for insertion of the disposable container into the recess and engagement of the first detent without opening of the disposable container closure.

75. The apparatus of claim 74, wherein the second detent engages the disposable container in liquid-tight engagement.

76. The apparatus of claim 75, wherein upon engagement of the second detent with the disposable container, the disposable container closure is opened.

77. The apparatus of claim 60, wherein liquid is pre-stored in the microfluidic device channel.

78. The apparatus of claim 60, wherein the apparatus is automated.

79. A method for processing molecules, the method comprising:
(a) providing at least first and second disposable containers, each of which comprises a cylinder with a plunger guided displaceably therein;
(b) providing a microfluidic device having at least one channel;
(c) operatively engaging the disposable containers to the microfluidic device; and
(d) displacing at least one of the plungers so that a liquid is conveyed from at least one of the disposable containers into the channel.

80. The method of claim 79, wherein the liquid is conveyed from the first disposable container into the second disposable container.

81. The method of claim 81, wherein as one of the disposable containers is being filled, the receiving container plunger is displaced by the pressure of the liquid.

82. The method of claim 79, wherein the liquid is displaced from at least one of the disposable containers into at least one microfluidic device chamber selected from the group consisting of a section of the channel, a microfluidic mixing chamber, a microfluidic reaction chamber, a microfluidic detection chamber, a bubble trap chamber, and any combination thereof.

83. The method of claim 82, wherein the channel section is meandering.

84. The method of claim 79, further comprising controlling the movement of liquid in the channel by opening and closing one or more valves in accordance with a predetermined program.

85. The method of claim 79, further comprising operatively connecting the disposable container to the microfluidic device using a recess operatively associated with the microfluidic device.

86. The method of claim 85, further comprising displacing the disposable container in the recess into a first locking position in a liquid tight relationship.

87. The method of claim 86, wherein the disposable containers are operatively engaged by the microfluidic device connection to permit fluid to flow from the container into the microfluidic device.

88. The method of claim 79, wherein the method is automated.
